(19) United States
(12) Patent Application Publication
(10) Pub. No.: US 2015/0259974 A1
(43) Pub. Date: Sep. 17, 2015

(54) Reinforcement Structure for Sliding Shutter

(71) Applicant: Katsuya SAWADA, (US)

(72) Inventor: Katsuya Sawada, Tottori (JP)

(21) Appl. No.: 14/417,890

(22) PCT Filed: Aug. 8, 2013
(86) PCT No.: PCT/JP2013/071475

§ 371 Date: Jan. 28, 2015

(30) Foreign Application Priority Data
Aug. 22, 2012 (JP) 2012-183160

(51) Int. Cl. E06B 9/17; E06B 9/02

(52) U.S. Cl. CPC E06B 9/17; E06B 9/02

(57) ABSTRACT

To provide a reinforcement structure for a sliding shutter wherein a small amount of power can transition said reinforcement structure to a state in which a reinforcing body reinforces the sliding shutter. [Solution] This reinforcement structure is for a sliding shutter provided with shutter plates that are guided by a pair of guide rails provided vertically along both sides of an opening in a building and can open and close said opening. The reinforcement structure is provided with a rod-shaped reinforcing body that can extend and contract. One end of said reinforcing body is rotatably supported at the top end of one of the sides of the opening in the building. The other end of the reinforcing body can be attached and detached at the bottom end of the aforementioned side of the opening in the building and can also be attached and detached at either the bottom end of the other side of the opening in the building or the bottom edge of said opening, between the bottom ends of the two sides.

### TECHNICAL FIELD

The present invention relates to a reinforcement structure for a sliding shutter, and more particularly, to a reinforcement structure for a sliding shutter for reinforcing slat plates of the sliding shutter by a reinforcement body which is diagonally placed in parallel to the slat plates.

### BACKGROUND ART

A sliding shutter for opening and closing a building opening makes guide rails placed on both side edges of the building opening guide a shutter plate configured of a plurality of slat plates which are vertically connected to each other, and opens and closes the building opening (for example, Patent Document 1). According to such a sliding shutter, if it is blasted by strong wind, there is concern that the slat plates rattle and collide against the guide rails, therefore noise is easily generated, and the slat plates get beaten by wind pressure and are damaged.

Hence, to solve these problems, the applicant of the present application proposes several shutter reinforcement structures. For example, a reinforcement structure 100 for a sliding shutter described in Patent Document 2 includes a hollow longitudinally long outer member 102. One end of the outer member 102 is rotatably mounted on an upper end of one (101a) of a pair of left and right guide rails 101a and 101b of the sliding shutter, and the other end of the outer member 102 is open. The reinforcement structure 100 also includes an inner member 103 which is inserted into the outer member 102 such that the inner member 103 can extend and retract, and a connecting member 104 which is rotatably connected to a tip end of the inner member 103. The connecting member 104 can attach to and detach from a lower end of the shutter plate 103 which is guided by the other guide rail 101b to vertically slide. The outer member 102, the inner member 103 and the connecting member 104 configure a reinforcement body 105, and the reinforcement body 105 reinforces the shutter plate 103.

According to this configuration, if the shutter plate 103 is pulled down to close the sliding shutter, the connecting member 104 slides downward along the guide rails 101a and 101b in association with downward movement of the shutter plate 103 while keeping a state where the one end of the outer member 102 is mounted on the upper end of the one guide rail 101a. Therefore, since the reinforcement body 105 diagonally extends from the upper end of the one guide rail 101a to the lower end of the other guide rail 101b, it is possible to reinforce the shutter plate 103 which is placed between both the guide rails.

According to a reinforcement structure 200 for a sliding shutter described in Patent Document 3, a pair of reinforcement body rails 202 are provided along guide rails 201. The reinforcement structure 200 includes a longitudinally long reinforcement body 205. Both ends of the reinforcement body 205 are slidably held by a pair of reinforcement body rails 203, respectively, and the reinforcement body 205 is erected or provided in the vicinity of a shutter plate 204. The reinforcement structure 200 also includes suspending members 206 from which the ends of the reinforcement body 205 are suspended. The suspending member 206 holds the reinforcement body 205 substantially horizontally at a predetermined height. The reinforcement structure 200 also includes a rotation body 207 around which the suspending member 206 can be wound up. Since the reinforcement structure 200 is configured as described above, if the suspending member 206 is wound up around the rotation body 207 or the suspending member 206 is wound off from the rotation body 207, a height of the reinforcement body 205 which is driven up from above against downwardly falling motion of the suspending member 206 by its own weight can be moved up or down. Therefore, the sliding shutter can be reinforced only by rotating the rotation body 207. Hence, when a large sliding shutter is to be reinforced, it is possible to easily reinforce the sliding shutter.

### PRIOR ART DOCUMENT

### Patent Documents

### Patent Document 1: JP 2004-176263 A

### Patent Document 2: JP 4456158 B1

### Patent Document 3: JP 4677594 B1

### DISCLOSURE OF THE INVENTION

### Problems to be Solved by the Invention

However, to reinforce a shutter plate of a sliding shutter, since it is necessary that a reinforcement body is strong, the reinforcement body becomes heavy in weight. According to the reinforcement structure 100 for a sliding shutter of Patent Document 2, the reinforcement body 105 is shifted from the state where the reinforcement body 105 is diagonally provided into the state where the reinforcement body 105 is horizontally held on an upper portion of a building opening by utilizing the vertical movement of the shutter plate 103. Therefore, if the sliding shutter is an electric shutter, a weight of the reinforcement body 105 is added to a motor which winds up and winds back the shutter plate 103, and there is concern that an excessive load is added to the motor. Even if the sliding shutter is a sliding shutter which manually winds up and winds back the shutter plate 103, an extra load is applied to the sliding shutter by a weight of the reinforcement body 105 at the time of opening/closing operation.

According to the reinforcement structure 200 for a sliding shutter of Patent Document 3, since the reinforcement body 205 is suspended from the suspending member 206, large power is required for rotating the rotation body 207.

Hence, it is an object of the present invention to provide a reinforcement structure for a sliding shutter capable of bringing, with small power, a reinforcement body into a state where the reinforcement body reinforces the sliding shutter.

### Solution to the Problems

A first reinforcement structure for a sliding shutter including a shutter plate which is guided by a pair of guide rails provided in a vertical direction along both side edges of a building opening and which can open and close the building opening, wherein the reinforcement structure includes a reinforcement body which is formed into a rod shape capable of extending and contracting, one end of the reinforcement body is rotatably supported by an upper end of one of the both side edges, and the other end of the reinforcement body is attachable to and detachable from a lower end of the one side edge, and is attachable to and detachable from a lower end of the other side edge or a lower edge of the building opening between the lower end of the one side edge and the lower end of the other side edge.

In a second reinforcement structure for a sliding shutter, the other end of the reinforcement body is provided with a wheel capable of moving along the lower edge of the building opening.

A third reinforcement structure for a sliding shutter further includes power means which drives the wheel.

In a fourth reinforcement structure for a sliding shutter, insertion holes are provided in the lower end of the one side edge of the building opening, the lower end of the other side edge of the building opening, or in a predetermined position of the lower edge of the building opening between the lower end of the one side edge and the lower end of the other side edge, and an inserting member which can be inserted into the insertion hole is swingably fixed to the other end of the reinforcement body.

In a fifth reinforcement structure for a sliding shutter, electro permanent magnets capable of holding the other end of the reinforcement body are provided on the lower end of the one side edge of the building opening, the lower end of the other side edge of the building opening, or at a predetermined position of the lower edge of the building opening between the lower end of the one side edge and the lower end of the other side edge of the building opening.

A sixth reinforcement structure for a sliding shutter including a shutter plate which is guided by a pair of guide rails provided in a vertical direction along both side edges of a building opening and which can open and close the building opening, wherein the reinforcement structure further includes a rail provided along an upper edge of the building opening, and a reinforcement body which is formed into a rod shape capable of extending and contracting, one end of the reinforcement body is slidably supported by the rail, and the other end of the reinforcement body is rotatably supported by a lower end of one of both the side edges.

A seventh reinforcement structure for a sliding shutter further includes power means which makes the one end of the reinforcement body slide on the rail.

In an eighth reinforcement structure for a sliding shutter, fixing means which attachably and detachably fix one end of the reinforcement body are provided on one end and the other end of the rail, or the one end of the rail, and between the one end and the other end of the rail.

In a ninth reinforcement structure for a sliding shutter, the fixing means are electro permanent magnets capable of holding the other end of the reinforcement body.

### Effects of the Invention

According to the first reinforcement structure for a sliding shutter, the reinforcement body is formed into the rod shape capable of extending and contracting, the one end of the reinforcement body is rotatably supported by the upper end of one of the both side edges of the building opening, and the other end of the reinforcement body is attachable to and detachable from the lower end of the one side edge of the building opening. Therefore, when the shutter plate of the sliding shutter is moved up to open the building opening, i.e., when the reinforcement body does not reinforce the shutter plate of the sliding shutter, the other end of the reinforcement body is engaged with the lower end of the one side edge of the building opening. According to this, the reinforcement body stands along the one side edge of the building opening, and the reinforcement body does not hinder the coming-in/out movement of the building opening.

Further, when the shutter plate of the sliding shutter is lowered to close the building opening, i.e., when the reinforcement body reinforces the shutter plate of the sliding shutter, the other end of the reinforcement body is engaged with the lower end of the other side edge of the building opening or the lower edge of the building opening between the lower end of the one side edge and the lower end of the other side edge of the building opening. According to this, it is possible to reinforce the shutter plate of the sliding shutter.

The reinforcement body can be brought from the state where the shutter plate is not reinforced into the state where the shutter plate is reinforced only by moving the other end of the reinforcement body substantially in the horizontal direction along the lower edge of the building opening. Therefore, it is possible to shift, with a small force, the reinforcement body into the state where the reinforcement body reinforces the sliding shutter irrespective of a weight of the reinforcement body.

According to the second reinforcement structure for a sliding shutter, since the other end of the reinforcement body is provided with the wheel which can move along the lower edge of the building opening, it is possible to move the other end of the reinforcement body along the lower edge of the building opening by the wheel. Therefore, the reinforcement body can be brought from the state where the shutter plate is not reinforced into the state where the shutter plate is reinforced without lifting up the reinforcement body. Hence, it is possible to shift, with a small force, the reinforcement body into the state where the reinforcement body reinforces the sliding shutter irrespective of a weight of the reinforcement body.

According to the third reinforcement structure for a sliding shutter, since the wheel is driven by the power means, it is possible to automatically bring the reinforcement body from the state where the shutter plate is not reinforced into the state where the shutter plate is reinforced. Since the other end of the reinforcement body moves in the horizontal direction along the lower edge of the building opening as described above, the power means requires only a small force as compared with a case where the other end of the reinforcement body moves in the vertical direction. Hence, it is possible to lower an installation cost of the reinforcement structure for a sliding shutter. Since it is totally unnecessary to lift up the reinforcement body, even if a power source of the power means such as electricity is blocked off, it is possible to safely and manually bring the reinforcement body into the state where the reinforcement body reinforces the shutter plate.

According to the fourth reinforcement structure for a sliding shutter, insertion holes are provided in the lower end of the one side edge of the building opening, the lower end of the other side edge of the building opening, or the lower edge of the building opening between the lower end of the one side edge and the lower end of the other side edge, and an inserting member which can be inserted into the insertion hole is swingably fixed to the other end of the reinforcement body. Therefore, with the extremely simple configuration, the other end of the reinforcement body can be attached to and detached from the lower end of the one side edge and the lower end of the other side edge of the building opening, or the lower edge of the building opening between the lower end of the one side edge and the lower end of the other side edge.

According to the fifth reinforcement structure for a sliding shutter, the other end of the reinforcement body is held at respective positions by electro permanent magnets provided on the lower end of the one side edge, the lower end of the other side edge of the building opening, or the lower edge of the building opening between the lower end of the one side edge and the lower end of the other side edge. Here, the “electro permanent magnet” is formed by winding a coil electromagnet around a permanent magnet for example. In a non-energized state, the electromagnet is demagnetized, the other end of the reinforcement body is held by a magnetic force of the permanent magnet. In an energized state, the electromagnet is excited, a magnetic force of the permanent magnet and a magnetic force of the electromagnet are counterbalanced by each other, and the other end of the reinforcement body is released. Since the other end of the reinforcement body is held in the non-energized state, even when electricity is blocked off in the event of a power outage for example, the reinforcement body can reliably keep reinforcing the shutter plate of the sliding shutter.

According to the sixth reinforcement structure for a sliding shutter, the rail is provided along the upper edge of the building opening, the one end of the reinforcement body is slidably supported by the rail, and the other end of the reinforcement body is rotatably supported by the lower end of the one side edge of the building opening. Hence, when the building opening is opened, i.e., when the reinforcement body does not reinforce the shutter plate of the sliding shutter, the reinforcement body stands along the one side edge of the building opening by sliding the one end of the reinforcement body to the one side edge of the building opening along the rail, and the building opening does not hinder the coming-in/out movement of the building opening.

When the shutter plate of the sliding shutter is lowered to close the building opening, i.e., when the reinforcement body reinforces the shutter plate of the sliding shutter, if the one end of the reinforcement body is slid toward the side edge of the other end of the building opening along the rail, the shutter plate of the sliding shutter can be reinforced.

In this manner, the reinforcement body can be brought from the state where the shutter plate is not reinforced into the state where the shutter plate is reinforced only by sliding the one end of the reinforcement body on the rail provided along the upper edge of the building opening in the horizontal direction. Therefore, it is possible to shift, with a small force, the reinforcement body into the state where the reinforcement body reinforces the sliding shutter irrespective of a weight of the reinforcement body.

According to the seventh reinforcement structure for a sliding shutter, the reinforcement structure includes the power means which makes the one end of the reinforcement body slide on the rail. Hence, it is possible to automatically bring the reinforcement body from the state where the shutter plate is not reinforced into the state where the shutter plate is reinforced. Since the one end of the reinforcement body moves in the horizontal direction in accordance with the rail provided along the upper edge of the building opening as described above, only a small force is required for the power means as compared with a case where the reinforcement body moves in the vertical direction, and the installation cost of the reinforcement structure for a sliding shutter can be lowered.

According to the eighth reinforcement structure for a sliding shutter, fixing means which attachably and detachably fix the one end of the reinforcement body are provided on the one end and the other end of the rail, or the one end of the rail, and between the one end and the other end of the rail. Therefore, it is possible to reliably hold the reinforcement body in the state where the shutter plates are not reinforced and the state where the shutter plates are reinforced, and it is possible to prevent the reinforcement body from moving unexpectedly.

According to the ninth reinforcement structure for a sliding shutter, since the fixing means is the electro permanent magnet which can hold the other end of the reinforcement body, the other end of the reinforcement body is held in the non-energized state in the same manner as described above. Therefore, even when electricity is blocked off in the event of a power outage for example, the reinforcement body can reliably keep reinforcing the shutter plate of the sliding shutter.

### BRIEF DESCRIPTION OF THE DRAWINGS

FIG. 1 is a diagram showing a state where a reinforcement body does not reinforce a shutter plate in a reinforcement structure for a sliding shutter according to a first embodiment.

FIG. 2 is a diagram showing a state where an inserting member of the reinforcement body is pulled out from an insertion hole in the reinforcement structure for a sliding shutter of the first embodiment.

FIG. 3 is a diagram showing a halfway state where the inserting member of the reinforcement body is moved toward the other side edge of a building opening in the reinforcement structure for a sliding shutter of the first embodiment.

FIG. 4 is a diagram showing a state where the inserting member of the reinforcement body is inserted into an insertion hole formed in a lower end of the other side edge of the building opening in the reinforcement structure for a sliding shutter of the first embodiment.

FIG. 5 is a sectional view taken along line I-I in a portion II-II in FIG. 1.

FIG. 6 is an enlarge diagram of a portion a in FIG. 3.

FIG. 7 is an enlarge diagram of a portion b in FIG. 1.

FIG. 8 is an enlarge diagram of a portion c in FIG. 4.

FIGS. 9(A) and 9(B) are partially omitted plan views of the reinforcement body for illustrating motion of a handle.

FIG. 10 is a diagram showing a state where a reinforcement body does not reinforce a shutter plate in a reinforcement structure for a sliding shutter of a second embodiment.

FIG. 11 is an enlarged diagram of a portion d in FIG. 10.

FIG. 12 is a halfway state where a slide portion of the reinforcement body is moved toward the other side edge of a building opening in the reinforcement structure for a sliding shutter of the second embodiment.

FIG. 13 is an enlarged diagram of a portion e in FIG. 12.

FIG. 14 is a diagram showing a state where an inserting member of the reinforcement body is inserted into an insertion hole formed in a lower end of the other side edge of the building opening in the reinforcement structure for a sliding shutter of the second embodiment.

FIG. 15 is an enlarged diagram of a portion f in FIG. 14.

FIGS. 16 (A) to 16(C) are diagrams for illustrating motion of the inserting member which slides in a cylindrical portion.

FIG. 17 is a diagram showing a state where a reinforcement body does not reinforce a shutter plate in a reinforcement structure for a sliding shutter in a state where electro permanent magnets are provided on lower ends of both side edges of a building opening as a modification of the second embodiment.

FIG. 18 is a diagram showing a state where the reinforcement body reinforces the shutter plate in the reinforcement structure for a sliding shutter in the state where electro permanent magnets are provided on the lower ends of the both side edges of the building opening as a modification of the second embodiment.

FIG. 19 is a diagram showing a state where a first reinforcement body and a second reinforcement body do not reinforce a shutter plate in a reinforcement structure for a sliding shutter of a third embodiment.

FIG. 20 is a diagram showing a state where the first reinforcement body and the second reinforcement body reinforce the shutter plate in the reinforcement structure for a sliding shutter of the third embodiment.

FIG. 21 is a diagram showing a state where a reinforcement body does not reinforce a shutter plate in a reinforcement structure for a sliding shutter of a fourth embodiment.

FIG. 22 is a diagram showing a halfway state where a moving body of the reinforcement body is moved toward the other side edge of a building opening in the reinforcement structure for a sliding shutter of the fourth embodiment.

FIG. 23 is an enlarged diagram of a portion g in FIG. 22.

FIG. 24 is a diagram showing a state where the reinforcement body reinforces the shutter plate in the reinforcement structure for a sliding shutter of the fourth embodiment.

FIG. 25 is a sectional view showing a configuration of a rail and the moving body of the fourth embodiment.

FIG. 26 is a diagram showing one example of a conventional reinforcement structure for a sliding shutter.

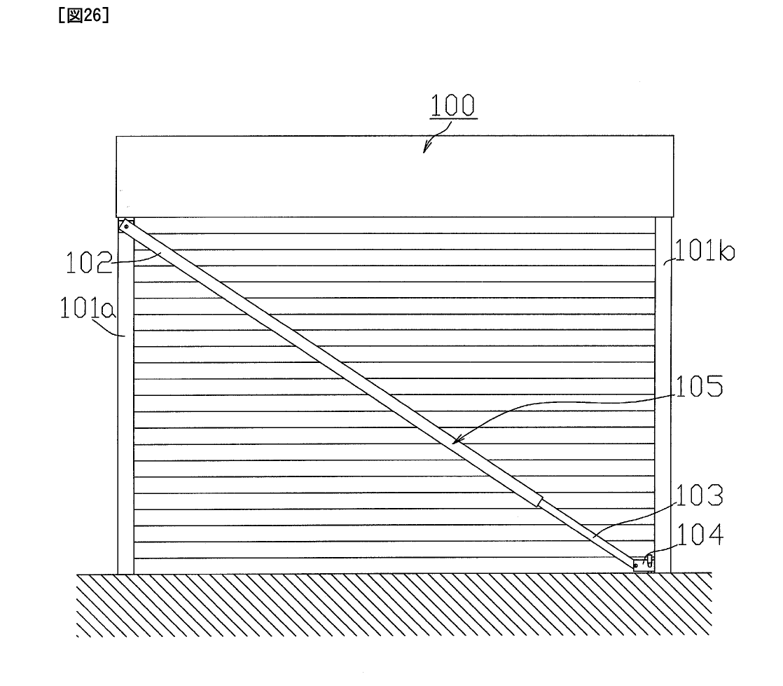

FIG. 27 is a diagram showing another conventional reinforcement structure for a sliding shutter.

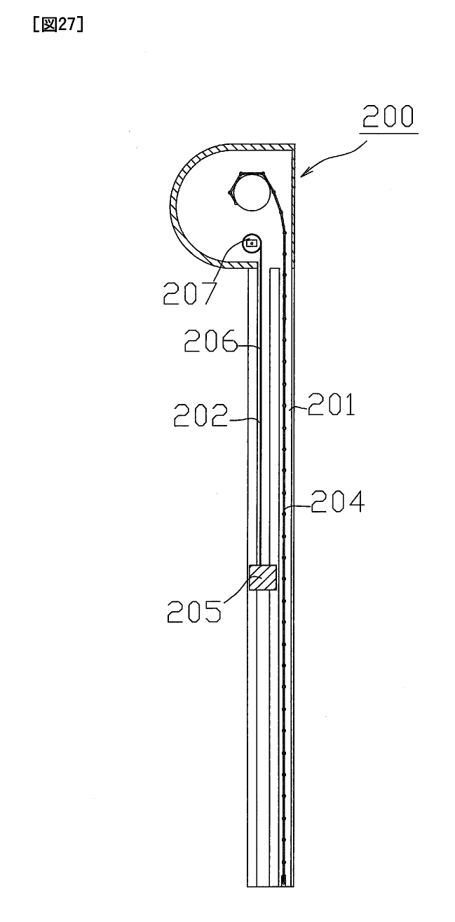

### MODES FOR CARRYING OUT THE INVENTION

### First Embodiment

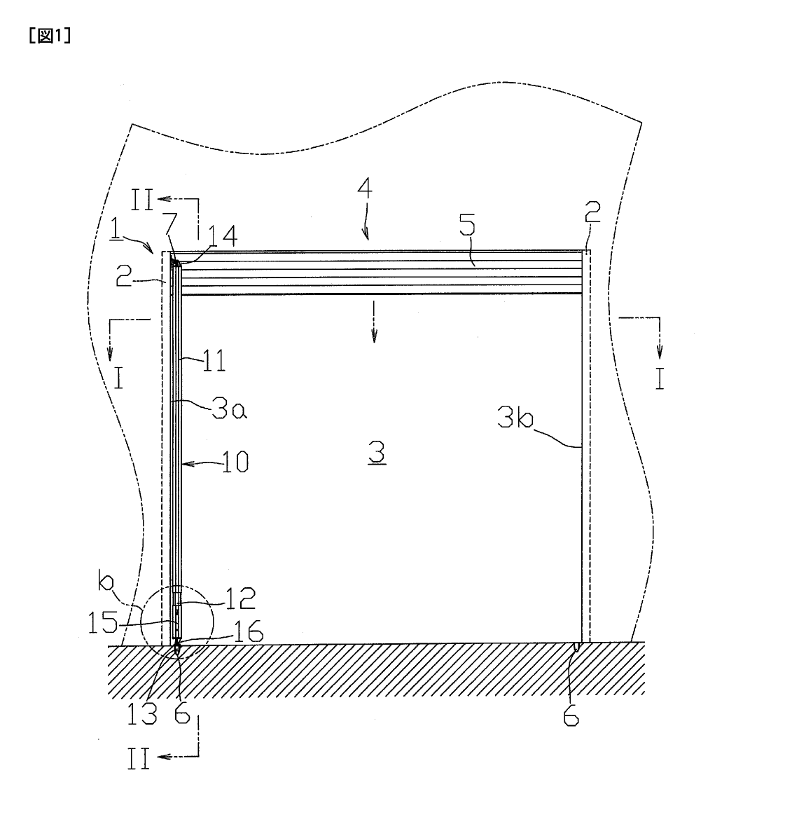

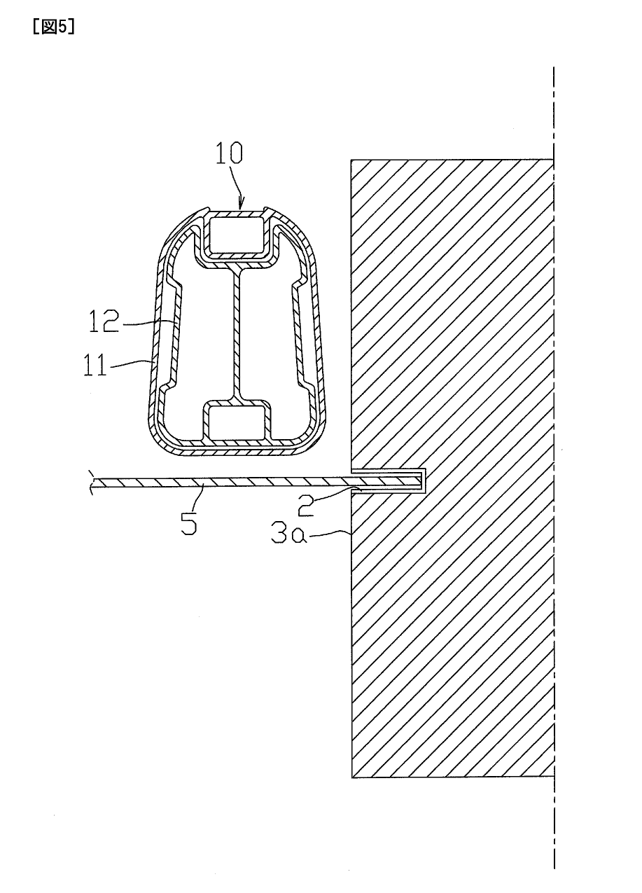

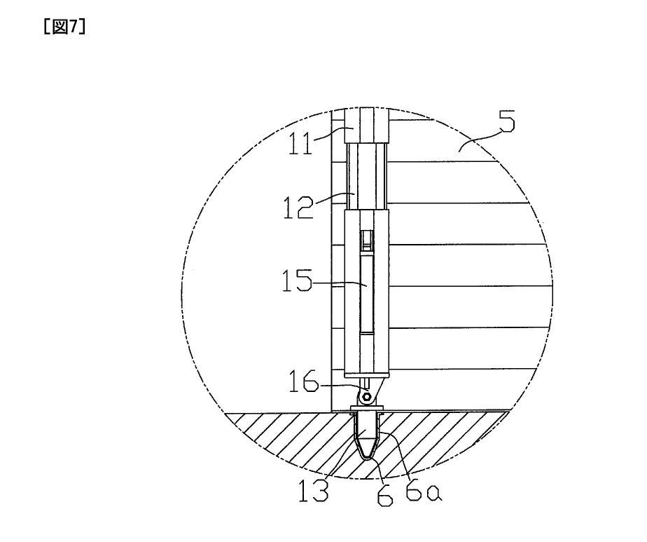

A reinforcement structure 1 for a sliding shutter according to a first embodiment of the present invention will be described with reference to FIGS. 1 to 9. As shown in FIG. 1, a sliding shutter 4 includes shutter plates 5 which are guided by a pair of guide rails 2 provided vertically along both side edges 3a and 3b of a building opening 3. The shutter plates 5 can open and close the building opening 3. The reinforcement structure 1 for a sliding shutter includes a reinforcement body 10 which is formed into a rod shape capable of extending and contracting. One end of the reinforcement body 10 is rotatably supported by an upper end of one (3a) of the side edges of the building opening 3, and the other end of the reinforcement body 10 is attachable to and detachable from a lower end of the one side edge 3a of the building opening 3 and a lower end of the other side edge 3b.

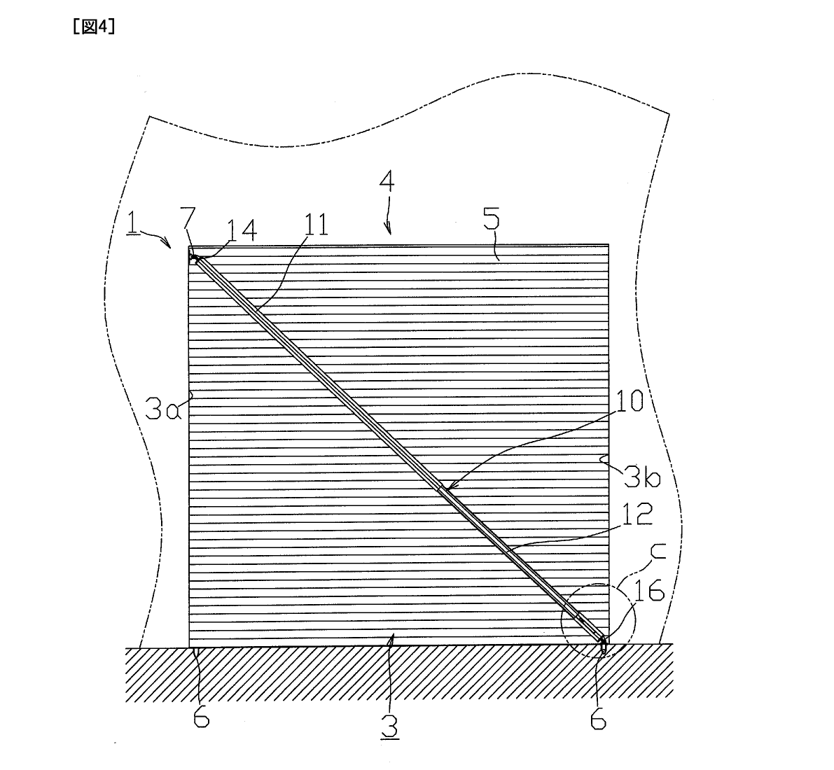

As shown in FIGS. 4 to 6, the reinforcement body 10 includes a hollow outer member 11, an inner member 12 which can be inserted into the outer member 11, and an inserting member 13 which can be inserted into insertion holes 6 formed in a lower edge of the building opening 3. The outer member 11 has a cylindrical shape, and one end of the outer member 11 includes a bracket 14 which is rotatably fixed to a support portion 7 provided on an upper end of the one side edge 3a of the building opening 3. The other end of the outer member 11 is open so that the inner member 12 can be inserted into the outer member 11. The inner member 12 is formed into a longitudinal shape having such a thickness that the inner member 12 can be inserted into the outer member 11. The inner member 12 is inserted into the outer member 11 from one end side thereof such that the inner member 12 can be pulled out therefrom. A portion of the other end side of the inner member 12 is thicker than an inner surface of the outer member 11, and when the inner member 12 is inserted into the outer member 11, the portion of the other end side of the inner member 12 is pulled out from the outer member 11.

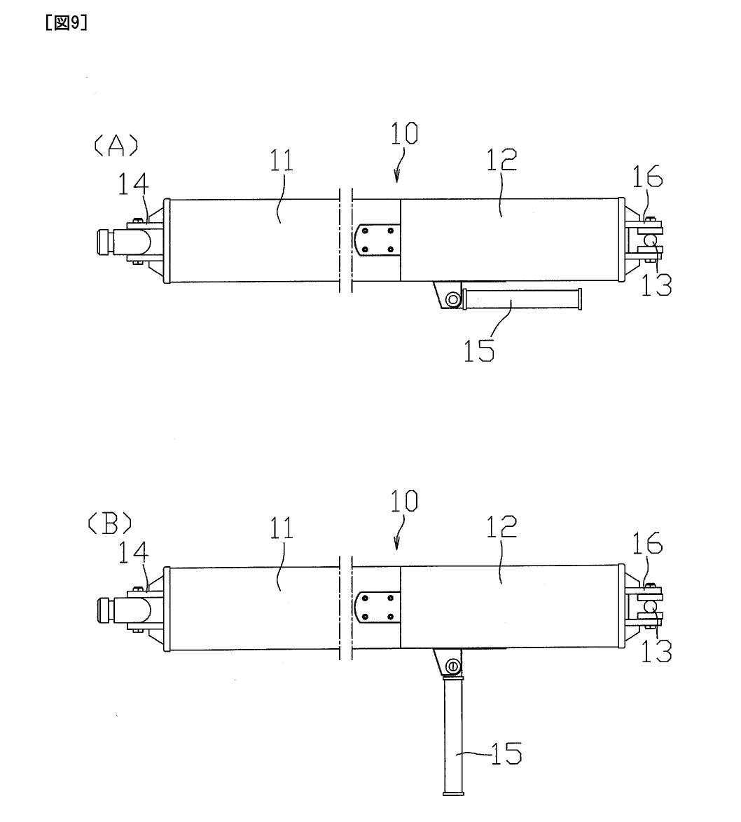

As shown in FIG. 9, a handle 15 is provided on one of surfaces of the inner member 12 which is not opposed to the shutter plates 5. A base end of the handle 15 is turnably fixed to a side surface of the inner member 12. The base end of the handle 15 can turn between a state where the base end is parallel to the inner member 12 as shown in FIG. 9(A) and a state where the base end vertically projects from the inner member 12 as shown in FIG. 9(B). A connection portion 16 is formed on the other end side of the inner member 12. The connection portion 16 fixes the inserting member 13 such that it can swing.

As the outer member 11 and the inner member 12, it is possible to use members made of light weighted and high strength resin such as fiber-reinforced plastic using a carbon fiber or a glass fiber, but the outer member 11 and the inner member 12 can be made of various materials having such strength that the shutter plates 5 can be reinforced such as metal, wood and resin. The inserting member 13 has a columnar shape having a base end which is swingably fixed to the connection portion 16 formed on the other end of the inner member 12. A tip end of the inserting member 13 has a conical shape.

In this embodiment, the one end of the outer member 11 is rotatably supported by an upper edge of the one side edge 3a of the building opening 3, and the connection portion 16 is formed on the other end of the inner member 12, but the inner member 12 and the outer member 11 may be provided reversely. That is, one end of the inner member 12 may be rotatably supported by the upper edge of the one side edge 3a of the building opening 3, and the connection portion 16 may be configured on the other end of the outer member 11. This is because that according to this configuration also, the reinforcement body 10 can extend and contract. The reinforcement body 10 is not limited to this configuration, and other configurations may be employed only if the reinforcement body 10 can extend and contract and can reinforce the shutter plates 5 of the sliding shutter 4.

Insertion holes 6 are respectively provided in lower ends of the both the side edges 3a and 3b of the building opening 3. The insertion holes 6 are formed by forming holes in a floor surface of the building opening 3 such as concrete for example, and by inserting bottomed-cylindrical receiving portions 6a having such sizes that the inserting member 13 can be inserted into the receiving portions 6a. The receiving portions 6a can be pulled out from the holes so that when rain water or foreign matter accumulates in the receiving portions 6a, they can easily be removed. Although the insertion holes 6 are illustrated in the drawings for convenience of illustration, the insertion holes 6 only open upward in reality, and the insertion holes 6 can not be seen in a front view of the reinforcement structure 1 for a sliding shutter.

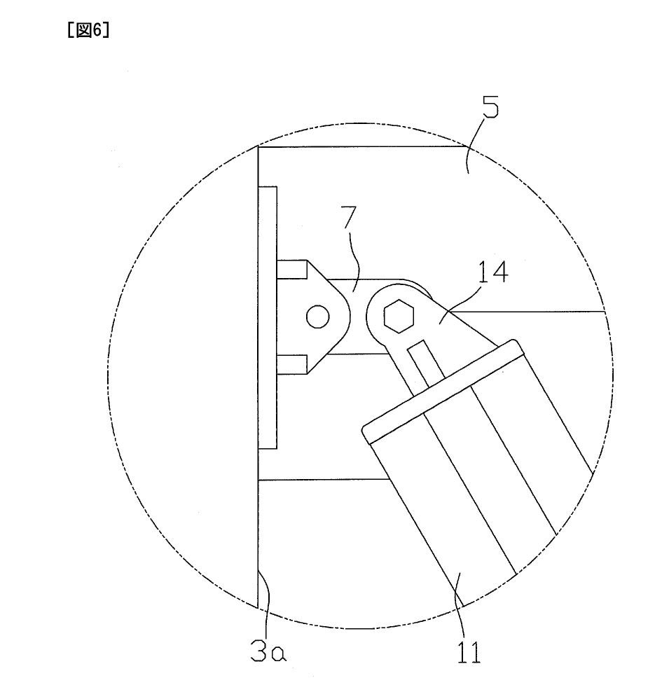

Next, an operation when the shutter plates 5 of the sliding shutter 4 are reinforced using the reinforcement structure 1 for a sliding shutter will be described. First, as shown in FIG. 1, the shutter plates 5 are lowered along the guide rails 2, and the opened building opening 3 is closed. At this time, the reinforcement body 10 is held in a state where it stands upright on the one side edge 3a of the building opening 3. As shown in FIG. 6, the inserting member 13 of the reinforcement body 10 is inserted into the insertion hole 6 formed in the lower end of the one side edge 3a of the building opening 3. Most portions of the inner member 12 are inserted into the outer member 11, but a portion of the inner member 12 can further be inserted into the outer member 11. Next, the handle 15 provided on the inner member 12 of the reinforcement body 10 is turned from a state where it is parallel to the inner member 12 as shown in FIG. 9(A) to a state where the handle 15 vertically projects from the inner member 12 as shown in FIG. 9(B).

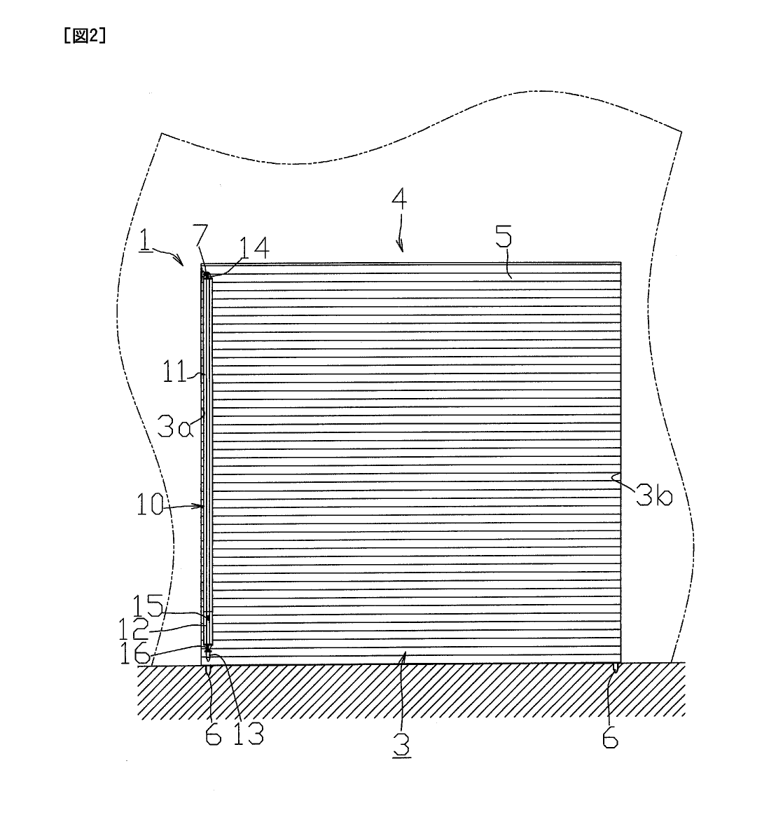

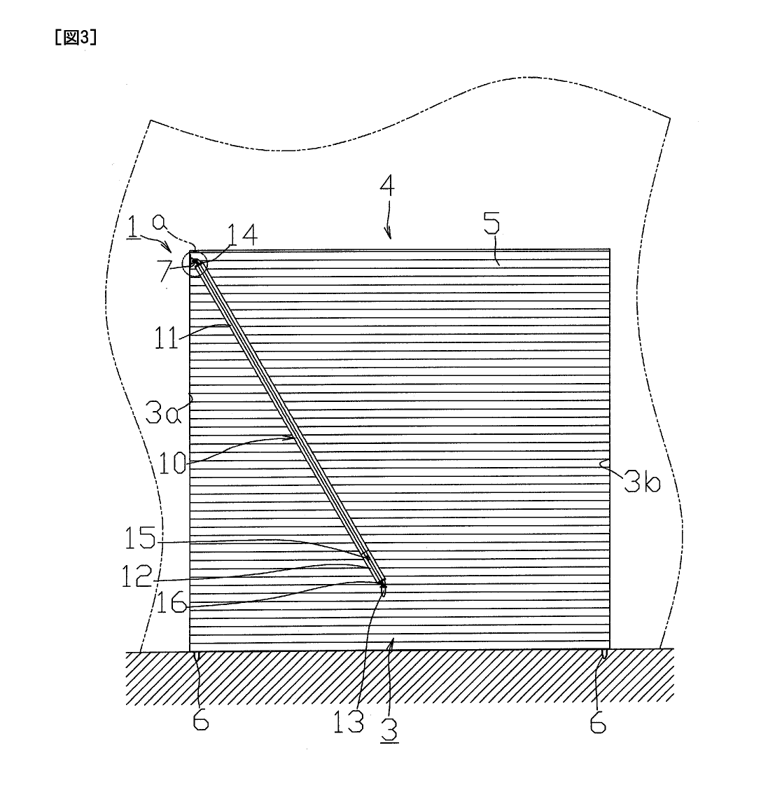

Next, the handle 15 which turns to project from the inner member 12 is grasped, and the inner member 12 is brought upward. According to this, the inner member 12 rises as shown in FIG. 2, a portion of the inner member 12 is further inserted into the outer member 11 and with this, the inserting member 13 is pulled out upward from the insertion hole 6. In a state where the handle 15 is kept grasped, the inserting member 13 of the reinforcement body 10 is moved toward the insertion hole 6 formed in the lower end of the other side edge 3b of the building opening 3 as shown in FIG. 3. The reinforcement body 10 rotates around the support portion 7.

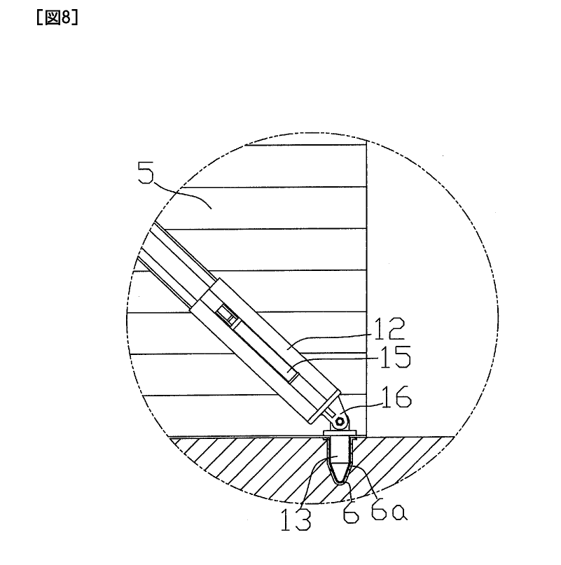

If the inserting member 13 of the reinforcement body 10 is moved toward the lower end side of the other side edge 3b of the building opening 3, since a distance between the inserting member 13 and the support portion 7 becomes long, the inner member 12 is gradually pulled out from the outer member 11 of the reinforcement body 10, and a length of the entire reinforcement body 10 becomes long. As shown in FIGS. 4 and 8, the inserting member 13 is inserted into the insertion hole 6 formed in the lower end of the other side edge 3b of the building opening 3. According to this, the reinforcement body 10 is diagonally provided in the building opening 3 as shown in FIG. 4, and the shutter plates 5 of the sliding shutter 4 can be reinforced.

According to the reinforcement structure 1 for a sliding shutter of the embodiment, the reinforcement body 10 can be brought from the state where the shutter plates 5 are not reinforced to the state where the shutter plates 5 are reinforced only by moving the other end of the reinforcement body 10 in the horizontal direction without largely bringing the other end of the reinforcement body 10 upward along the lower edge of the building opening 3. Therefore, the reinforcement body 10 can be shifted to the state where the reinforcement body 10 reinforces the sliding shutter 4 with a small force irrespective of a weight of the reinforcement body 10.

### Second Embodiment

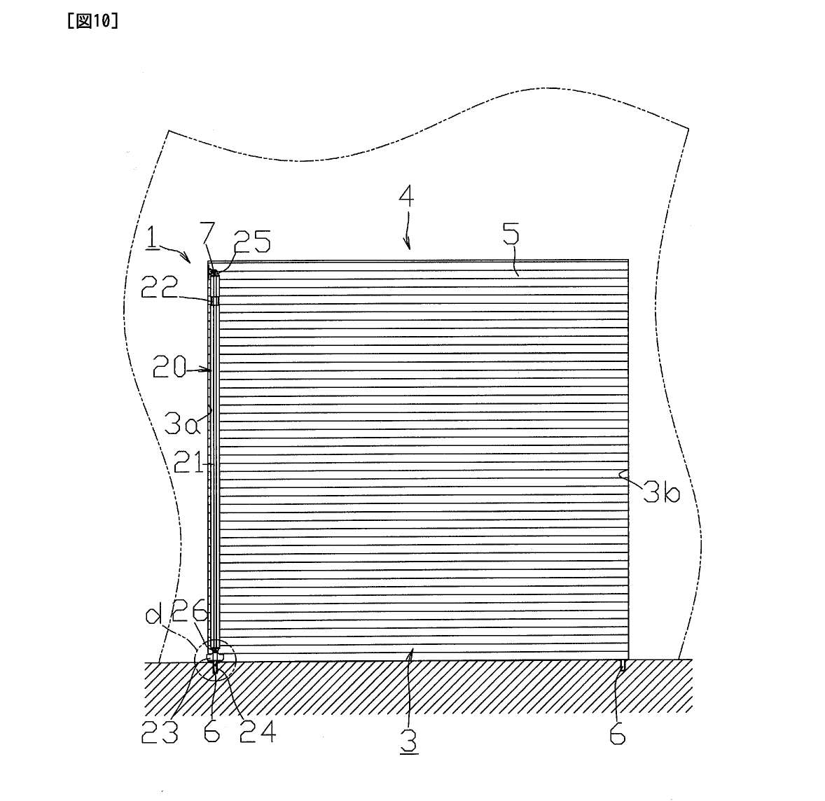

Next, a second embodiment of the present invention will be described with reference to FIGS. 10 to 16. The same reference signs are allocated to the same configurations as those of the first embodiment, and descriptions of the same configurations will be omitted. Similar to the first embodiment, a reinforcement structure 1 for a sliding shutter of the second embodiment includes a reinforcement body 20. One end of the reinforcement body 20 is rotatably supported by an upper end of the one side edge 3a of a building opening 3, and the other end of the reinforcement body 20 is attachable to and detachable from a lower end of the one side edge 3a and a lower end of the other side edge 3b of the building opening 3.

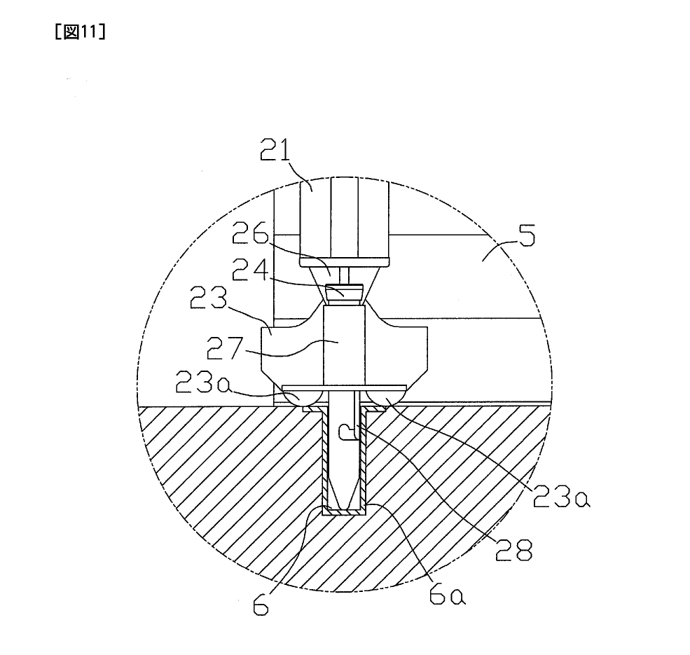

As shown in FIGS. 10 and 11, the reinforcement body 20 includes an inner member 22, a hollow outer member 21 into which the inner member 22 can be inserted, a slide portion 23 which is swingably fixed to one end of the outer member 21, and an inserting member 24 which can be inserted into an insertion hole 6 formed in a lower edge of the building opening 3.

The inner member 22 includes a bracket 25 which is rotatably fixed to a support portion 7 provided on the upper end of the one side edge 3a of the building opening 3. The other end side of the inner member 22 is formed into a longitudinal shape having such a thickness that the inner member 22 can be inserted into the outer member 21. The inner member 22 is inserted into the outer member 21 from its other end such that the inner member 22 can be pulled out from the outer member 21. A portion of one end side of the inner member 22 is thicker than an inner surface of the outer member 21. When the inner member 22 is inserted into the outer member 21, a portion of the one end side of the inner member 22 is pulled out from the outer member 21. Further, one end of the outer member 21 is open so that the inner member 22 can be inserted into the outer member 21. A connection portion 26 which swingably fixes a slide portion 23 is formed on the other end of the outer member 21.

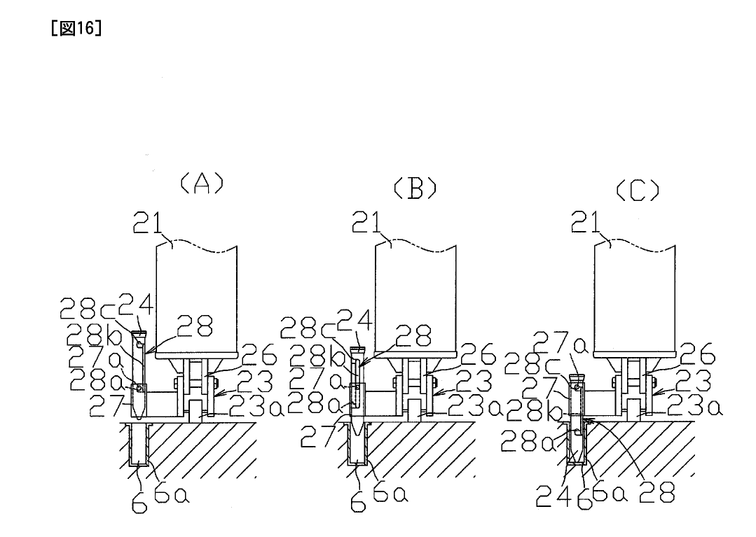

As shown in FIGS. 11 and 16, the slide portion 23 is swingably fixed to the connection portion 26 formed on the other end of the outer member 21. Two wheels 23a are provided on a lower portion of the slide portion 23 such that the wheels 23a can move along a lower edge of the building opening 3. The two wheels 23a are provided side by side in a traveling direction of the slide portion 23. A cylindrical portion 27 is provided on a side of the slide portion 23 opposite from a side where shutter plates 5 of the sliding shutter 4 are provided. The cylindrical portion 27 slidably holds the inserting member 24 in the vertical direction.

The cylindrical portion 27 is formed into a cylindrical shape, and a projection 27a is formed on an inner peripheral surface of the cylindrical portion 27. Meanwhile, the inserting member 24 is of a columnar shape having such a diameter that the inserting member 24 can be inserted into the cylindrical portion 27. A tip end of the inserting member 24 has a conical shape. A guide groove 28 is formed in an outer peripheral surface of the inserting member 24, and the projection 27a formed on the inner peripheral surface of the cylindrical portion 27 is accommodated in the guide groove 28. The guide groove 28 includes an upper holding portion 28a. The inserting member 24 abuts against the projection 27a in a state where a tip end of the inserting member 24 is located higher than a lower edge of the building opening 3, and the upper holding portion 28a restricts the projection 27a from sliding downward as shown in FIG. 16(A). The guide groove 28 also includes a slidable portion 28b which brings the inserting member 24 into a state where it can slide vertically as shown in FIG. 16(B), and a lower holding portion 28c which holds the inserting member 24 in a state where the inserting member 24 is inserted into the insertion hole 6 as shown in FIG. 16(C). That is, the guide groove 28 includes the upper holding portion 28a which extends, in the horizontal direction, toward a lower end of the slidable portion 28b extending in the vertical direction in a range of 90° of the outer periphery of the inserting member 24, and a tip end of the upper holding portion 28a slightly swells upward. The guide groove 28 also includes the lower holding portion 28c which extends toward an upper end of the slidable portion 28b in the horizontal direction in a range of 90° of the outer periphery of the inserting member 24.

Next, the operation when the shutter plates 5 of the sliding shutter 4 are reinforced using the reinforcement structure 1 for a sliding shutter of the embodiment will be described. First, as shown in FIG. 10, the shutter plates 5 are lowered along the guide rails 2, and the opened building opening 3 is closed. At this time, the reinforcement body 20 is held in a state where it stands upright on the one side edge 3a of the building opening 3. The inserting member 24 of the reinforcement body 20 is inserted into the insertion hole 6 formed in the lower end of the one side edge 3a of the building opening 3 as shown in FIGS. 11 and 16(C).

At this time, as shown in FIG. 16(C), the projection 27a of the cylindrical portion 27 is located on the lower holding portion 28c of the guide groove 28 of the inserting member 24. Then, the inserting member 24 is slightly lifted up and rotated 90°, and the inserting member 24 is moved such that the projection 27a is located on the slidable portion 28b of the guide groove 28 as shown in FIG. 16(B). The inserting member 24 is further lifted up so that the projection 27a abuts against a lower end of the slidable portion 28b, the inserting member 24 is rotated 90°, and the projection 27a is located on the upper holding portion 28a. According to this, the inserting member 24 is held in a state where it is pulled out from the insertion hole 6 upward.

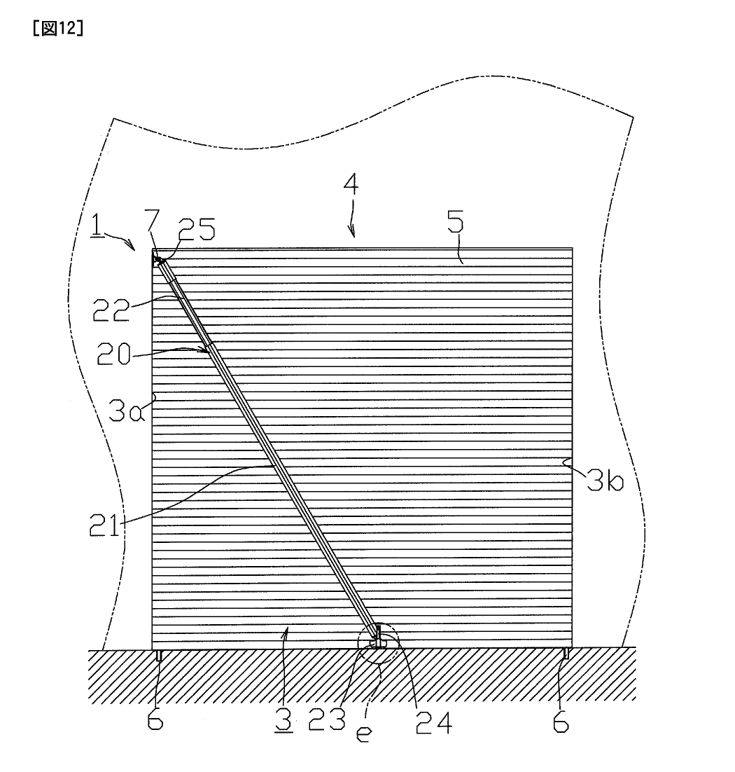

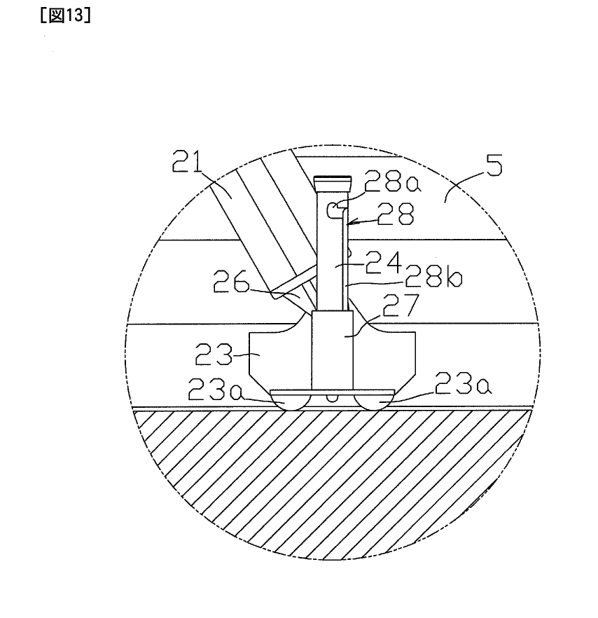

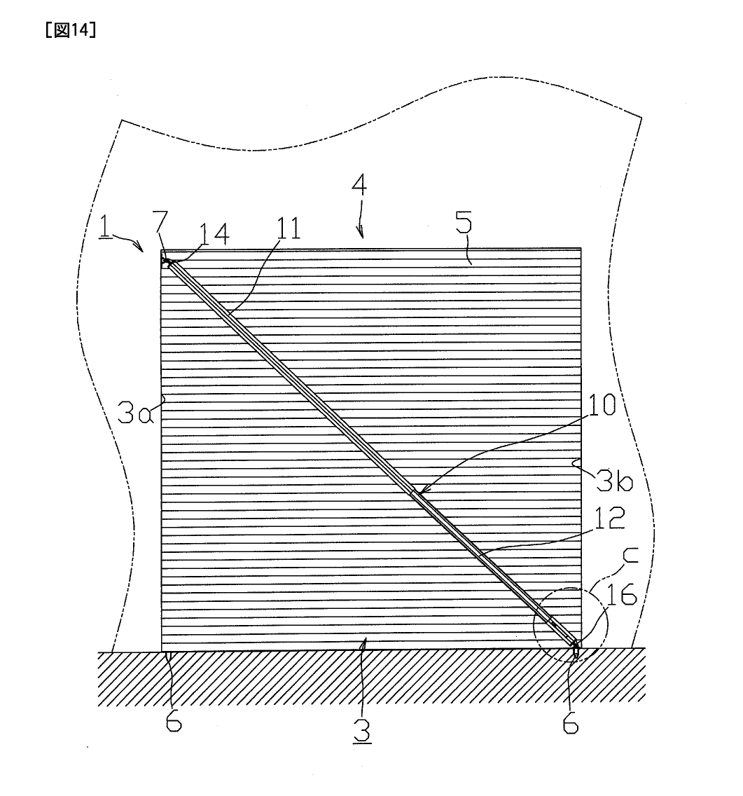

As shown in FIGS. 12 and 13, the slide portion 23 is moved along a lower edge of the building opening 3. If the wheels 23a rotate, the slide portion 23 moves along the lower edge of the building opening 3. Therefore, the end of the reinforcement body 20 can move from the lower end of the one side edge 3a to a lower end of the other side edge 3b of the building opening 3 without lifting up the reinforcement body 20 at all. At this time, the reinforcement body 20 rotates around the support portion 7. As shown in FIG. 14, if the slide portion 23 moves toward the lower end of the other side edge 3b of the building opening 3, a distance between the slide portion 23 and the support portion 7 becomes long, the inner member 22 is gradually pulled out from the outer member 21 of the reinforcement body 20, and a length of the entire reinforcement body 20 becomes long.

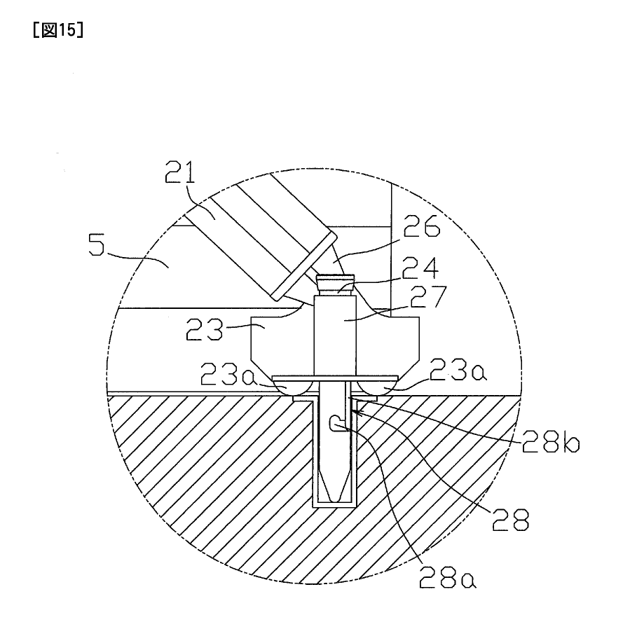

Further, as shown in FIG. 16, the inserting member 24 is rotated to relatively move the projection 27a from the upper holding portion 28a of the guide groove 28 to the slidable portion 28b. The inserting member 24 is slid downward, the projection 27a is relatively moved from a lower end to an upper end of the guide groove 28 while inserting the inserting member 24 into the insertion hole 6, the inserting member 24 is further rotated, and the projection 27a is held by the lower holding portion 28c of the guide groove 28. One end of the reinforcement body 20 is fixed to the upper end of the one side edge 3a of the building opening 3, and the other end of the reinforcement body 20 is fixed to the lower end of the other side edge 3b of the building opening 3 in this manner. Therefore, the reinforcement body 20 is diagonally provided on the building opening 3 as shown in FIGS. 14 and 15, and it is possible to reinforce the shutter plates 5 of the sliding shutter 4.

According to the reinforcement structure 1 for a sliding shutter of this embodiment, since the other end of the reinforcement body 20 can move along the lower edge of the building opening 3 by the wheels 23a, the shutter plates 5 can be shifted from the state where the shutter plates 5 are not reinforced to the state where the shutter plates 5 are reinforced without lifting up the reinforcement body 20. Hence, the reinforcement body 20 can be shifted to the state where the reinforcement body 20 reinforces the sliding shutter 4 with a small force irrespective of a weight of the reinforcement body 20.

Even if the slide portion 23 does not have special power, the slide portion 23 can easily move from the lower end of the one side edge 3a to the lower end of the other side edge 3b, but the slide portion 23 may have power means such as a motor (not shown). If the wheels 23a are driven by the power means in this manner, it is possible to automatically shift the reinforcement body 20 from the state where the shutter plates 5 are not reinforced to the state where the shutter plates 5 are reinforced. In this case also, it is only necessary to move the slide portion 23 in the horizontal direction along the lower edge of the building opening 3, only a small force is required for the power means, the power means does not need to produce large power, and the installation cost of the reinforcement structure 1 for a sliding shutter can be lowered. Further, since it is totally unnecessary to lift up the reinforcement body 20, even if a power source of the power means such as electricity is blocked off, it is possible to safely and manually bring the reinforcement body 20 into the state where it reinforces the shutter plates 5.

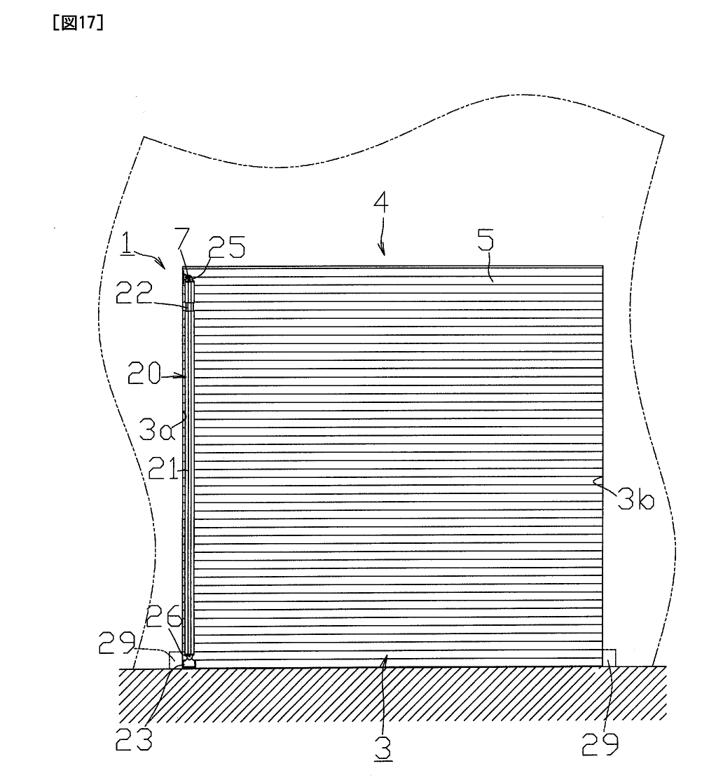

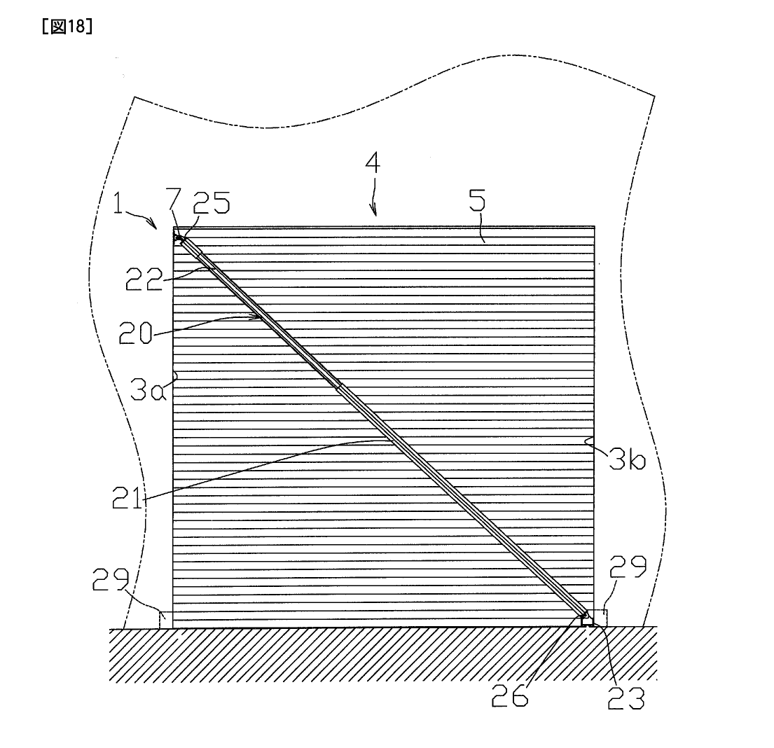

As shown in FIGS. 17 and 18, lower ends of both the side edges 3a and 3b of the building opening 3 may be provided with electro permanent magnets 29, respectively. In this case, it is unnecessary to provide the configurations of the cylindrical portion 27, the inserting member 24 and the insertion holes 6 in the second embodiment. The slide portion 23 is made of magnetic metal. Although it is not illustrated in the drawings, the electro permanent magnets 29 are formed by winding a coil electromagnet around a permanent magnet. In a non-energized state, the electromagnet is demagnetized, the permanent magnet attracts the slide portion 23. In an energized state, the electromagnet is excited, a magnetic force of the permanent magnet and a magnetic force of the electromagnet are counterbalanced by each other, and the slide portion 23 is released.

As shown in FIG. 17, in the state where the shutter plates 5 are not reinforced, the reinforcement body 20 is held in the state where it stands upright on the one side edge 3a of the building opening 3. At this time, the slide portion 23 is attracted to and fixed to the electro permanent magnet 29 which is provided on the lower end of the one side edge 3a of the building opening 3. When the shutter plates 5 are to be reinforced, the electro permanent magnet 29 is first energized, the slide portion 23 is released from the electro permanent magnet 29 and in this state, the slide portion 23 is moved toward the lower end of the other side edge 3b of the building opening 3 along the lower edge of the building opening 3.

If the wheels 23a rotate, the slide portion 23 moves along the lower edge of the building opening 3 as described above. Hence, the end of the reinforcement body 20 can move from the lower end of the one side edge 3a to the lower end of the other side edge 3b of the building opening 3 without lifting up the reinforcement body 20 at all. If the slide portion 23 moves toward the lower end of the other side edge 3b of the building opening 3 as shown in FIG. 18, a distance between the slide portion 23 and the support portion 7 becomes long. Hence, the inner member 22 is gradually pulled out from the outer member 21 of the reinforcement body 20, and a length of the entire reinforcement body 20 becomes long. The slide portion 23 is attracted to and fixed to the electro permanent magnets 29 which is provided on the lower end of the other side edge 3b of the building opening 3. Since the other end of the reinforcement body 20 is held in the non-energized state, even when electricity is blocked off in the event of a power outage, the reinforcement body 20 can reliably keep reinforcing the shutter plates 5 of the sliding shutter 4.

### Third Embodiment

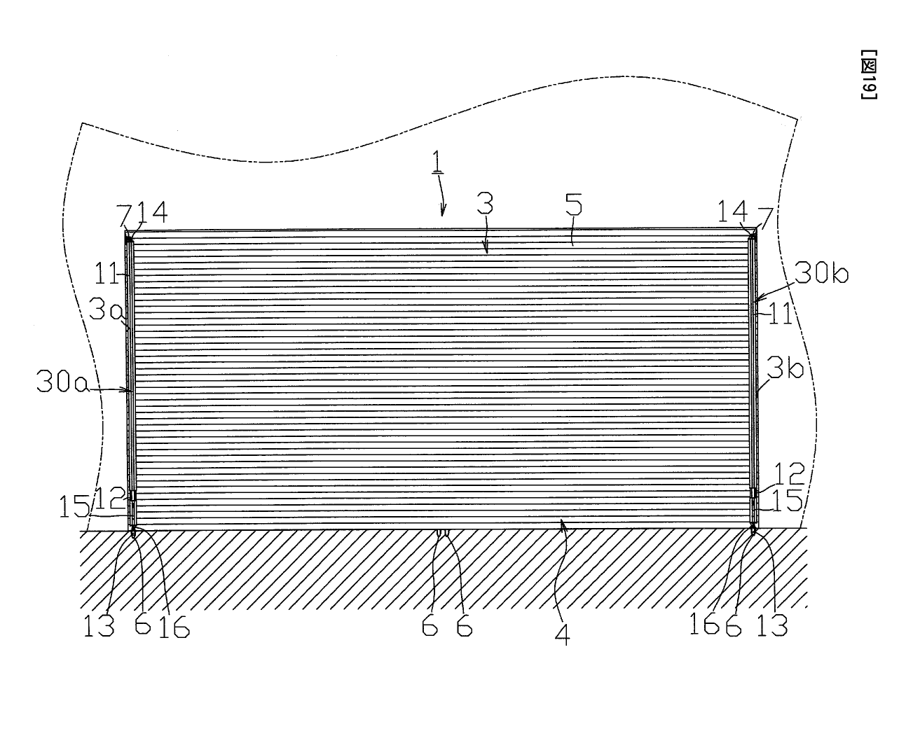

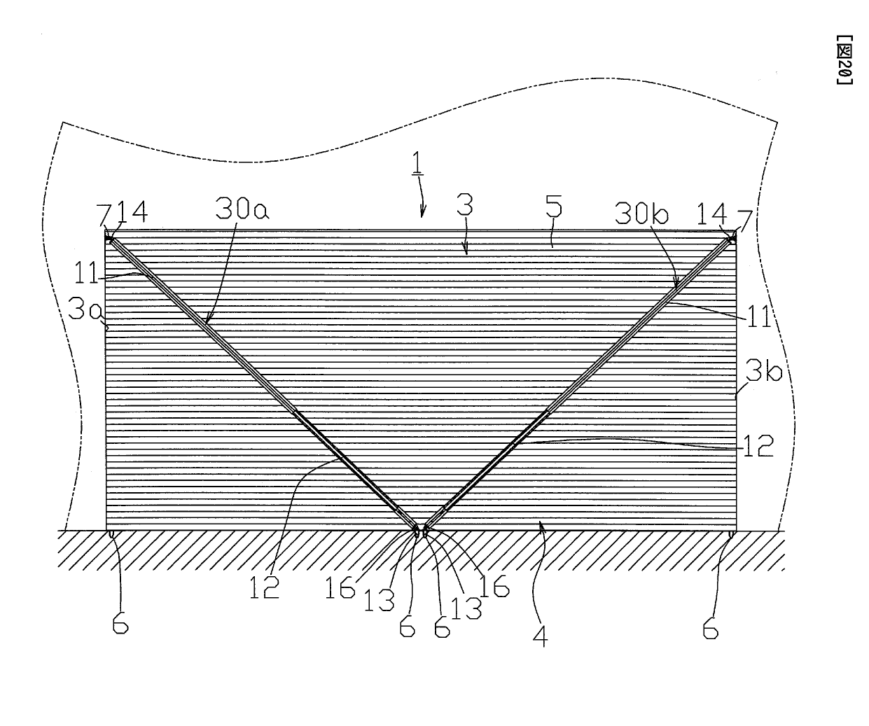

Next, a reinforcement structure 1 for a sliding shutter according to a third embodiment of the present invention will be described with reference to FIGS. 19 and 20. Since members configuring reinforcement bodies 30a and 30b have the same configurations as those of the first embodiment, the same reference signs are allocated to the same configurations, and descriptions thereof will be omitted. As shown in FIG. 19, the reinforcement structure 1 for a sliding shutter of the third embodiment includes the two reinforcement bodies 30a and 30b. That is, the reinforcement structure 1 for a sliding shutter includes the first reinforcement body 30a which is formed into a rod shape capable of extending and contracting. One end of the first reinforcement body 30a is rotatably supported by an upper end of one side edge 3a of a building opening 3, and the other end can be attached to and detached from a lower end of the one side edge 3a of the building opening 3 and between the lower end of the one side edge 3a and the lower end of the other side edge 3b of the building opening 3. The reinforcement structure 1 also includes the second reinforcement body 30b having the same configuration as that of the first reinforcement body 30a. On end of the second reinforcement body 30b is rotatably supported by an upper end of the other side edge 3b of the building opening 3, and the other end of the second reinforcement body 30b can be attached to and detached from the lower end of the one side edge 3a of the building opening 3 and between the lower end of the one side edge 3a and the lower end of the other side edge 3b of the building opening 3. Insertion holes 6 are provided in the lower end of the one side edge 3a and the lower end of the other side edge 3b of the building opening 3, and two insertion holes 6 are also formed side by side in central portions of a lower edge of the building opening 3 between both the side edges 3a and 3b of the building opening 3.

When the shutter plates 5 of the sliding shutter 4 are to be reinforced using the reinforcement structure 1 for a sliding shutter, the shutter plates 5 are first lowered along the guide rails 2 as shown in FIG. 19, and the opened building opening 3 is closed. At this time, the first reinforcement body 30a is held in a state where it stands upright on the one side edge 3a of the building opening 3, and the second reinforcement body 30b is held in a state where it stands upright on the other side edge 3b of the building opening 3. Next, the handles 15 provided on the inner members 12 of the first reinforcement body 30a and the second reinforcement body 30b are turned from a state where the handles 15 are parallel to the inner members 12 as shown in FIG. 9(A) to a state where the handles 15 vertically project from the inner members 12 as shown in FIG. 9(B).

The handle 15 is grasped and the inner member 12 of the first reinforcement body 30a is lifted up. According to this, the inner member 12 rises, a portion of the inner member 12 is further inserted into the outer member 11 and with this, the inserting member 13 is pulled out upward from the insertion hole 6. In a state where the handle 15 is kept grasped, the inserting member 13 of the first reinforcement body 30a is inserted into the insertion hole 6 provided between the lower end of the one side edge 3a and the lower end of the other side edge 3b of the building opening 3 as shown in FIG. 20. Similarly, the inner member 12 of the second reinforcement body 30b is lifted up as shown in FIG. 19. According to this, the inner member 12 rises, a portion of the inner member 12 is further inserted into the outer member 11 and with this, the inserting member 13 is pulled out upward from the insertion hole 6. In a state where the handle 15 is kept grasped, the inserting member 13 of the second reinforcement body 30b is inserted into the insertion hole 6 provided between the lower end of the one side edge 3a and the lower end of the other side edge 3b of the building opening 3 as shown in FIG. 20.

According to this, one end of the first reinforcement body 30a is fixed to the upper end of the one side edge 3a of the building opening 3, one end of the second reinforcement body 30b is fixed to the upper end of the other side edge 3b of the building opening 3, the other end of the first reinforcement body 30a and the other end of the second reinforcement body 30b are engaged with central portions of the lower edge of the building opening 3. Therefore, the first reinforcement body 30a and the second reinforcement body 30b are placed to form a V-shape, and the shutter plates 5 of the sliding shutter 4 can be reinforced. According to this, even when the width of the building opening 3 is wide, i.e., even when one reinforcement body exceeds its upper limit of extension and contraction and the shutter plates 5 of the sliding shutter 4 can not appropriately be reinforced, or even when loads applied to both the ends of the reinforcement body become excessively large if one reinforcement body reinforces the shutter plates 5, it is possible to appropriately reinforce the shutter plates 5 of the sliding shutter 4 by placing the two reinforcement bodies 30a and 30b in the V-shape.

### Fourth Embodiment

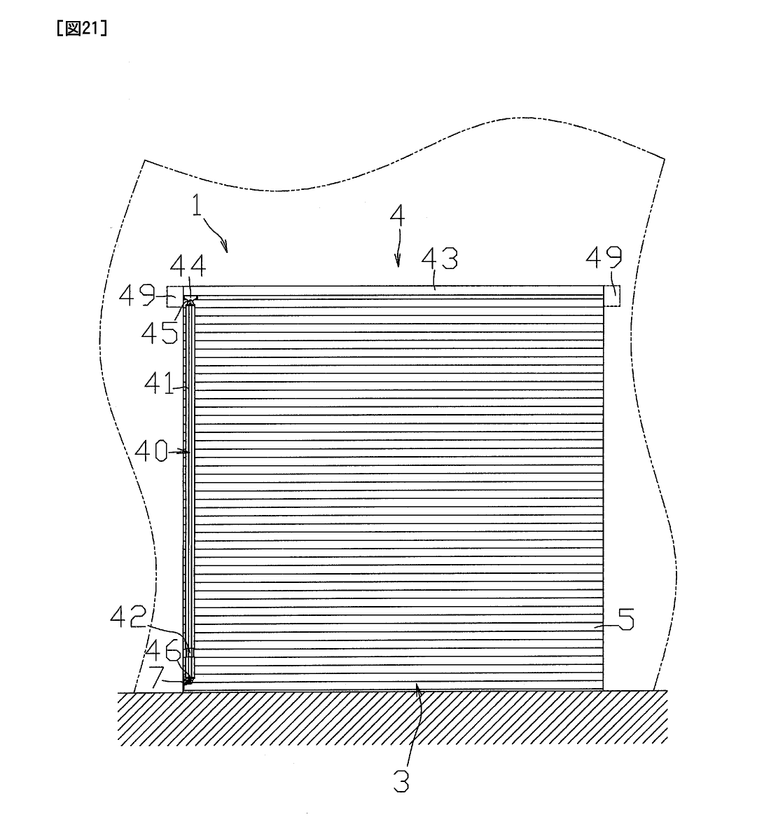

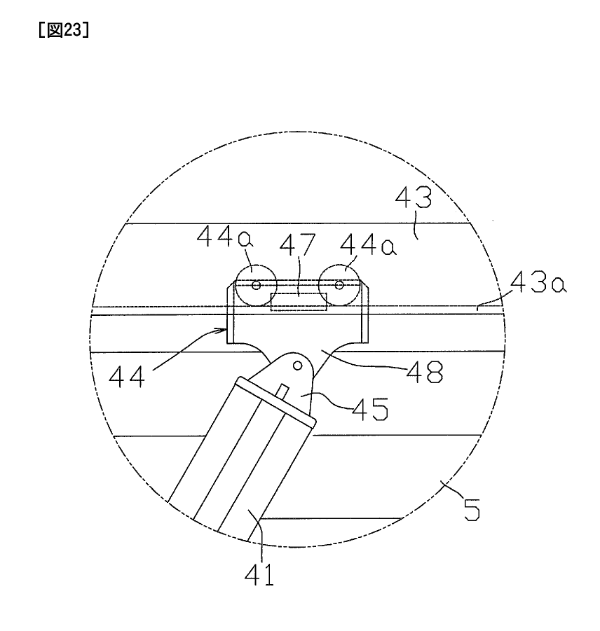

Next, a reinforcement structure 1 for a sliding shutter according to a fourth embodiment of the present invention will be described with reference to FIGS. 21 to 25. The same reference signs are allocated to the same configurations as those of the first to third embodiments, and descriptions of the same configurations will be omitted. The reinforcement structure 1 for a sliding shutter of the fourth embodiment includes a rail 43 provided along an upper edge of a building opening 3, and a reinforcement body 40 which is formed into a rod shape capable of extending and contracting. One end of the reinforcement body 40 is slidably supported by the rail 43, and the other end of the reinforcement body 40 is rotatably supported by a lower end of one (3a) of both side edges 3a and 3b.

The reinforcement body 40 includes a moving portion 44 having wheels 44a which can be driven along the rail 43, a hollow outer member 41 whose one end is swingably fixed to the moving portion 44, and an inner member 42. One end of the inner member 42 can be inserted into the outer member 41 and the other end of the inner member 42 is turnably fixed to a lower end of the one side edge 3a of the building opening 3. The outer member 41 is formed into a cylindrical shape, and one end of the outer member 41 has a swinging portion 45 which is swingably fixed to the moving portion 44. The other end of the outer member 41 is open so that the inner member 42 can be inserted into the outer member 41. The inner member 42 is formed into a longitudinal shape having such a thickness that the inner member 42 can be inserted into the outer member 41. The inner member 42 is inserted into the outer member 41 from its one end such that the inner member 42 can be pulled out from the outer member 41. A portion of the other end of the inner member 42 is thicker than an inner surface of the outer member 41, and when the inner member 42 is inserted into the outer member 41, the portion of the other end of the inner member 42 is pulled out from the outer member 41. A bracket 46 is formed on the other end of the inner member 42. The bracket 46 is rotatably supported by a support portion 7 provided on the one side edge 3a of the building opening 3.

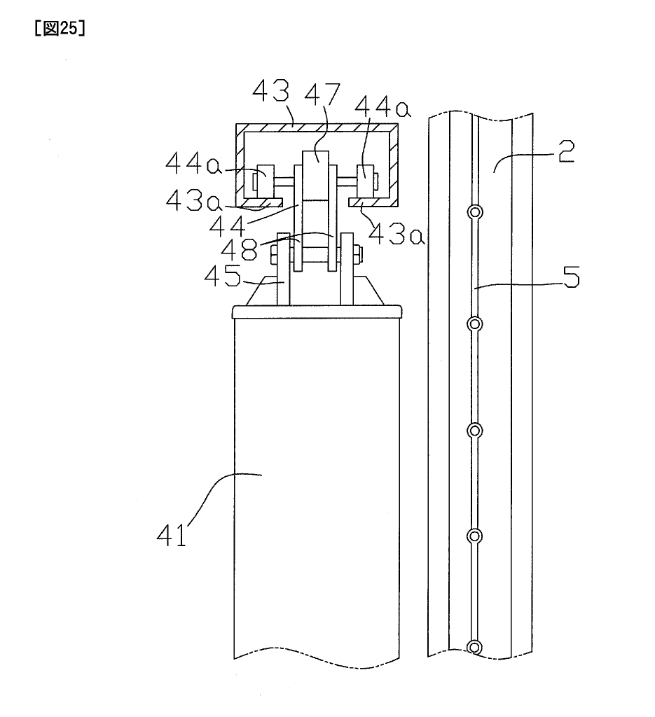

As shown in FIG. 25, the rail 43 is a lip channel steel which is placed such that it opens downward. The moving portion 44 has a total of four wheels 44a provided two each in front and back in a moving direction. The wheels 44a are placed on a lip portion 43a of the rail 43. A motor 47 as power means which drives the wheels 44a is fixed to the moving portion 44. Suspending portions 48 downwardly suspending from the opening of the rail 43 are provided between the wheels 44a of the moving portion 44, and the suspending portions 48 turnably support the swinging portion 45 formed on the one end of the outer member 41.

electro permanent magnets 49 as fixing means are provided on both ends of the rail 43, i.e., on upper ends of both the side edges 3a and 3b of the building opening 3. The electro permanent magnet 49 detachably fix the moving portion 44. The moving portion 44 is made of magnetic metal, and is attracted to and fixed to the electro permanent magnet 49 in a non-energized state.

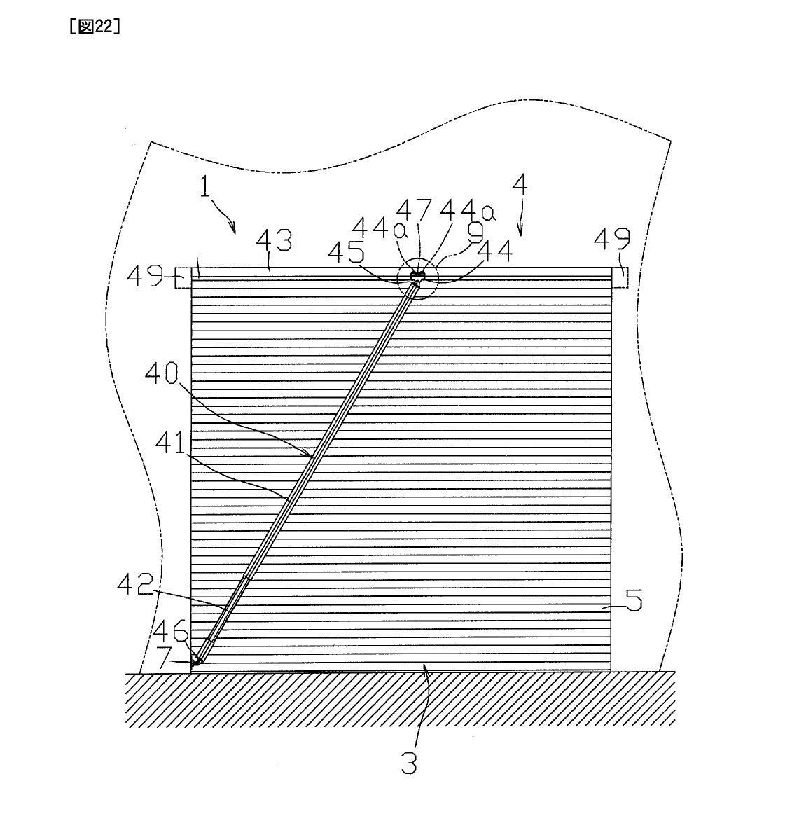

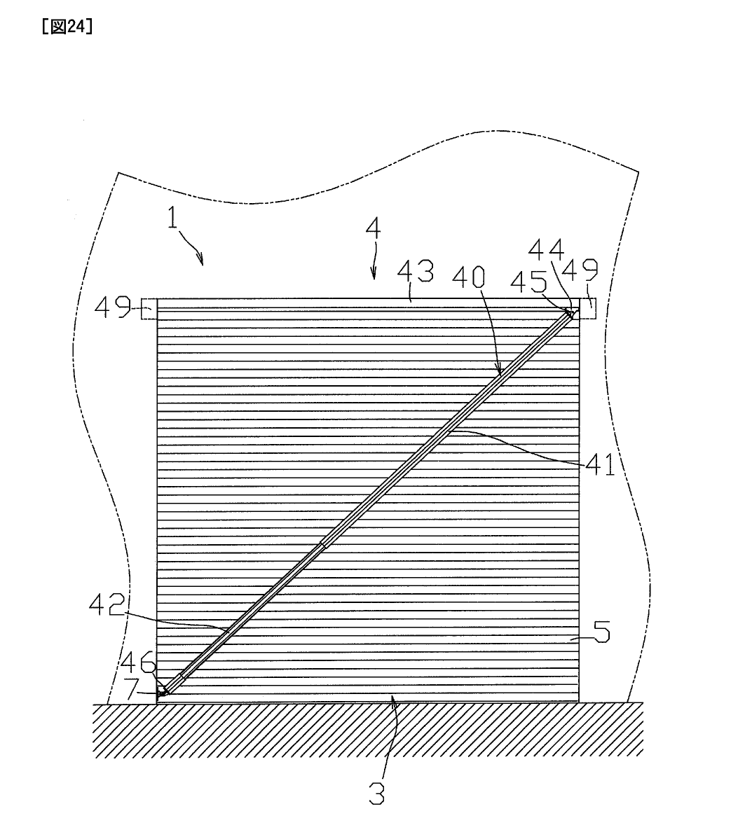

When the shutter plates 5 of the sliding shutter 4 are to be reinforced using the reinforcement structure 1 for a sliding shutter of the fourth embodiment, the shutter plates 5 are first lowered along guide rails 2 and the opened building opening 3 is closed as shown in FIG. 21. At this time, the reinforcement body 40 is held in a state where it stands upright on the one side edge 3a of the building opening 3. The moving portion 44 of the reinforcement body 40 is attracted to and fixed to the electro permanent magnet 49 which is provided on the upper end of the one side edge 3a of the building opening 3. Next, the electro permanent magnets 49 are energized to release the moving portion 44, the motor 47 of the moving portion 44 is driven, and the moving portion 44 is moved along the rail 43 as shown in FIG. 22. If the moving portion 44 is moved to the other end of the rail 43 as shown in FIG. 24, a distance between the moving portion 44 and the support portion 7 provided on the lower end of the one side edge 3a of the building opening 3 becomes long. Therefore, the inner member 42 is gradually pulled out from the outer member 41 of the reinforcement body 40, and a length of the entire reinforcement body 40 becomes long. The moving portion 44 is attracted to and fixed to the electro permanent magnet 49 which is provided on the other end of the rail 43.

The reinforcement body 40 can be shifted from the state where the shutter plates 5 are not reinforced to the state where the shutter plates 5 are reinforced only by moving the moving portion 44 along the rail 43 provided in the horizontal direction along the upper edge of the building opening 3. Hence, it is possible to shift, with a small force, the reinforcement body 40 into the state where the reinforcement body 40 reinforces the sliding shutter 4 irrespective of a weight of the reinforcement body 40. By providing the motor 47 as the power means, it is possible to automatically shift the reinforcement body 40 from the state where the shutter plates 5 are not reinforced to the state where the shutter plates 5 are reinforced. In this case, the moving portion 44 moves in the horizontal direction in accordance with the rail 43 provided along the upper edge of the building opening 3 as described above. Therefore, a force required for the power means may be small as compared with a case where the moving portion 44 moves in the vertical direction, and an installation cost of the reinforcement structure 1 of the sliding shutter can be lowered.

The electro permanent magnets 49 capable of holding the other end of the reinforcement body 40 are provided on the one end and the other end of the rail 43 in the non-energized state. Therefore, even if electricity is blocked off in the event of a power outage, the reinforcement body 40 can reliably keep reinforcing the shutter plates 5 of the sliding shutter 4.

The modes for carrying out the present invention are not limited to the above-described embodiments, and the modes can appropriately be changed within a range not departing from the scope of the spirit of the present invention of course.

### INDUSTRIAL APPLICABILITY

The Reinforcement structure 1 for a sliding shutter according to the present invention can suitably be used as a reinforcement structure 1 for a sliding shutter which reinforces shutter plates 5 of a sliding shutter 4 provided in a building opening 3.

### DESCRIPTION OF REFERENCE SIGNS

1 reinforcement structure for a sliding shutter
2 guide rail
3 building opening
3a one side edge
3b the other side edge
4 sliding shutter
5 shutter plate
6 insertion hole
10, 20, 40 reinforcement body
13, 24 inserting member
29, 49 electro permanent magnet
30a first reinforcement body
30b second reinforcement body
47 motor (power means)

1. A reinforcement structure for a sliding shutter including a shutter plate which is guided by a pair of guide rails provided in a vertical direction along both side edges of a building opening and which can open and close the building opening, the reinforcement structure comprising:
a reinforcement body which is formed into a rod shape capable of extending and contracting, one end of the reinforcement body is rotatably supported by an upper end of one of the both side edges, and the other end of the reinforcement body is attachable to and detachable from a lower end of the one side edge, and is attachable to and detachable from a lower end of the other side edge or a lower edge of the building opening between the lower end of the one side edge and the lower end of the other side edge.

2. The reinforcement structure for a sliding shutter according to claim 1, wherein the other end of the reinforcement body is provided with a wheel capable of moving along the lower edge of the building opening.

3. The reinforcement structure for a sliding shutter according to claim 2, further comprising power means which drives the wheel.

4. The reinforcement structure for a sliding shutter according to claim 1, wherein insertion holes are provided in the lower end of the one side edge of the building opening, the lower end of the other side edge of the building opening, or the lower edge of the building opening between the lower end of the one side edge and the lower end of the other side edge, and an inserting member which can be inserted into the insertion hole is swingably fixed to the other end of the reinforcement body.

5. The reinforcement structure for a sliding shutter according to claim 1, wherein electro permanent magnets capable of holding the other end of the reinforcement body are provided on the lower end of the one side edge of the building opening, the lower end of the other side edge of the building opening, or at a predetermined position of the lower edge of the building opening between the lower end of the one side edge and the lower end of the other side edge of the building opening.

6. A reinforcement structure for a sliding shutter including a shutter plate which is guided by a pair of guide rails provided in a vertical direction along both side edges of a building opening and which can open and close the building opening, the reinforcement structure further comprising:
a rail provided along an upper edge of the building opening; and
a reinforcement body which is formed into a rod shape capable of extending and contracting, one end of the reinforcement body is slidably supported by the rail, and the other end of the reinforcement body is rotatably supported by a lower end of one of both the side edges.

7. The reinforcement structure for a sliding shutter according to claim 6, further comprising power means which makes the one end of the reinforcement body slide on the rail.

8. The reinforcement structure for a sliding shutter according to claim 6, wherein fixing means which attachably and detachably fix the one end of the reinforcement body are provided on one end and the other end of the rail, or the one end of the rail, and between the one end and the other end of the rail.

9. The reinforcement structure for a sliding shutter according to claim 8, wherein the fixing means are electro permanent magnets capable of holding the other end of the reinforcement body.

10. The reinforcement structure for a sliding shutter according to claim 2, wherein insertion holes are provided in the lower end of the one side edge of the building opening, the lower end of the other side edge of the building opening, or the lower edge of the building opening between the lower end of the one side edge and the lower end of the other side edge, and an inserting member which can be inserted into the insertion hole is swingably fixed to the other end of the reinforcement body.

11. The reinforcement structure for a sliding shutter according to claim 3, wherein insertion holes are provided in the lower end of the one side edge of the building opening, the lower end of the other side edge of the building opening, or the lower edge of the building opening between the lower end of the one side edge and the lower end of the other side edge, and an inserting member which can be inserted into the insertion hole is swingably fixed to the other end of the reinforcement body.

12. The reinforcement structure for a sliding shutter according to claim 2, wherein electro permanent magnets capable of holding the other end of the reinforcement body are provided on the lower end of the one side edge of the building opening, the lower end of the other side edge of the building opening, or at a predetermined position of the lower edge of the building opening between the lower end of the one side edge and the lower end of the other side edge of the building opening.

13. The reinforcement structure for a sliding shutter according to claim 3, wherein electro permanent magnets capable of holding the other end of the reinforcement body are provided on the lower end of the one side edge of the building opening, the lower end of the other side edge of the building opening, or at a predetermined position of the lower edge of the building opening between the lower end of the one side edge and the lower end of the other side edge of the building opening.

14. The reinforcement structure for a sliding shutter according to claim 7, wherein fixing means which attachably and detachably fix the one end of the reinforcement body are provided on one end and the other end of the rail, or the one end of the rail, and between the one end and the other end of the rail.

15. The reinforcement structure for a sliding shutter according to claim 14, wherein the fixing means are electro permanent magnets capable of holding the other end of the reinforcement body.
